(19) United States
(12) Patent Application Publication
(10) Pub. No.: US 2022/0012653 A1
(43) Pub. Date: Jan. 13, 2022

(54) ASSET WORK STRATEGIES USING WEATHER AND HISTORICAL DATA

(71) Applicant: International Business Machines Corporation, Armonk, NY (US)

(72) Inventors: Thiago Bianchi, Sao Carlos (BR); Thiago Roberto Fontes Iunes, Santos (BR)

(21) Appl. No.: 16/922,002

(22) Filed: Jul. 7, 2020

(51) Int. Cl. G06Q 10/06; G06F 17/18; G06K 9/62; G06N 20/00

(52) U.S. Cl. CPC G06Q 10/0633; G06Q 10/06315; G06N 20/00; G06K 9/6223; G06F 17/18

(57) ABSTRACT

One or more historical work data are received for one or more previously completely jobs. The historical work data is analyzed. The weather day for each previously completed job of the one or more previously completed jobs is received, wherein the weather data is at a time of completion of the previously completed job. A model is trained using the analyzed historic work data and the weather data. The model predicts a time deviation, a cost deviation, and crew qualifications based on a work order.

### BACKGROUND

The present invention relates generally to the field of asset work strategies, and more particularly to optimizing asset work strategies based on historical data related to weather and previously completed asset work plans.

Enterprise asset management (EAM) is the management of the maintenance of physical assets of an organization throughout the lifecycle of assets. EAM may also include setup, maintenance, or decommissioning of assets. EAM may be used to plan, optimize, execute, and track the needed maintenance activities with associated priorities, skills, materials, tools, and information. This may include the design, construction, commissioning, operations, maintenance, and decommissioning or replacement of equipment and facilities.

### SUMMARY

Embodiments of the present invention include a method, computer program product, and system for providing a work order strategy. In an embodiment, one or more historical work data are received for one or more previously completely jobs. The historical work data is analyzed. The weather day for each previously completed job of the one or more previously completed jobs is received, wherein the weather data is at a time of completion of the previously completed job. A model is trained using the analyzed historic work data and the weather data. The model predicts a time deviation, a cost deviation, and crew qualifications based on a work order.

### BRIEF DESCRIPTION OF THE DRAWINGS

FIG. 1 is a functional block diagram of a network computing environment, generally designated 100, suitable for operation of asset program 112, in accordance with at least one embodiment of the invention.

FIG. 2 is a flow chart diagram depicting operational steps for asset program 112 for training a model, in accordance with at least one embodiment of the invention.

FIG. 3 is a flow chart diagram depicting operational steps for asset program 112 for providing a strategy for a work order using the model, in accordance with at least one embodiment of the invention.

FIG. 4 is an example table depicting work orders and their associated data, in accordance with at least one embodiment of the invention.

FIG. 5 is a block diagram depicting components of a computer, generally designated 500, suitable for executing asset program 112, in accordance with at least one embodiment of the invention.

### DETAILED DESCRIPTION

Enterprise asset management (EAM) is the management of the maintenance of physical assets of an organization throughout the lifecycle of assets. EAM may handle operations such as installation, modification, upgrading, downgrading, decommissioning, maintenance, etc., of physical assets. EAM may receive work orders to perform any of the above-referenced operations or jobs. Work orders may include information about the job, including but not limited to, estimated time to complete, estimated cost to complete, and estimated crew qualifications to complete. The information may be about the overall work order or may be broken down to smaller aspects of a work order. In other words, the information may list a total cost of a work order or may list a cost for each individual part or aspect of a work order. EAM receives work orders and utilizes these work orders to plan and organize the work especially when there are large numbers of work orders received.

Embodiments of the present invention provide for provide at least for creating/updating/modifying a model for predicting and optimizing asset work plans. Embodiments of the present invention provide for receiving historical work data and historical weather data in order to create/update/modify the model. Embodiments of the present invention provide for receiving a work order and using a model to predict and optimize asset work plans. Embodiments of the present invention provide for implementing a chosen strategy for the work order. Embodiments of the present invention provide for reduced time and reduced costs for work orders using the model to provide an optimized asset work plan for the work order. Embodiments of the present invention provide for the use of the proper crew qualifications for a work order using the model to provide an optimized asset plan for the work order.

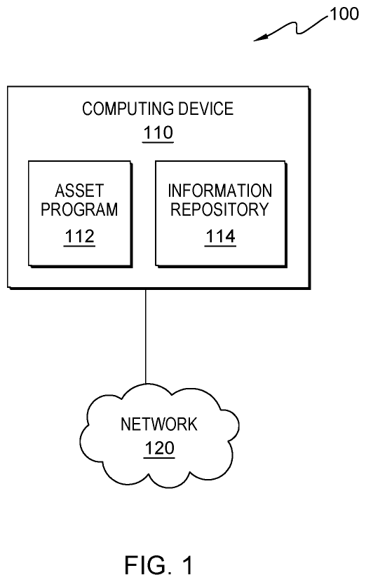

Referring now to various embodiments of the invention in more detail, FIG. 1 is a functional block diagram of a network computing environment, generally designated 100, suitable for operation of asset program 112 in accordance with at least one embodiment of the invention. FIG. 1 provides only an illustration of one implementation and does not imply any, limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 120.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes asset program 112 and information repository 114.

In an embodiment, computing device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes asset program 112. Embodiments of the present invention provide for an asset program 112 that creates/updates/modifies a model for predicting and optimizing asset work plans. In embodiments of the present invention, asset program 112 receives historical work data. In embodiments of the present invention, asset program 112 analyzes historical work data. In embodiments of the present invention, asset program 112 infers historical work data. In embodiments of the present invention, asset program receives historical weather data. In embodiments of the present invention, asset program 112 trains a model using the received historical work data and historical weather data. Embodiment of the present invention provide for an asset program 112 that receives a work order and provides an optimal strategy using a model. In embodiments of the present invention, asset program 112 receives a work order. In embodiments of the present invention, asset program 112 analyses the work order. In embodiments of the present invention, asset program 112 determines the model. In embodiments of the present invention, asset program 112 determines the weather. In embodiments of the present invention, asset program 112 provides a strategy. In embodiments of the present invention, asset program 112 receives an update from the user. In embodiments of the present invention, asset program 112 provides an updated strategy. In embodiments of the present invention, asset program 112 implements the strategy.

In an embodiment, computing device 110 includes information repository 114. In an embodiment, information repository 114 may be managed by asset program 112. In an alternative embodiment, information repository 114 may be managed by the operating system of computing device 110, another program (not shown), alone, or together with, asset program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided information repository 114 is accessible by computing device 110. Information repository 114 may include, but is not limited to, historical work data, work data templates, historical weather data, one or more models, received work orders, one or more strategies, implementation data, etc.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

As referred to herein, all data retrieved, collected, and used, is used in an opt in manner, i.e., the data provider has given permission for the data to be used. For example, the received data received and used by asset program 112 to create/update/modify the model.

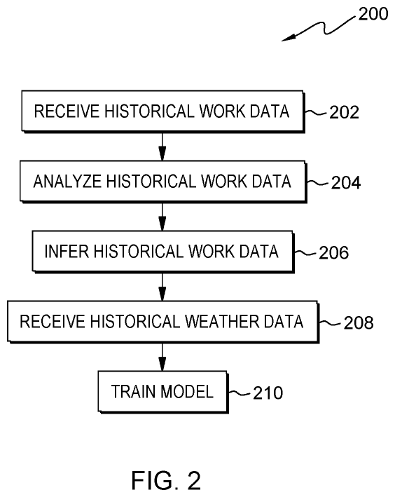

FIG. 2 is a flow chart diagram of workflow 200 depicting operational steps for asset program 112 in accordance with at least one embodiment of the invention. In an alternative embodiment, the steps of workflow 200 may be performed by any other program while working with asset program 112. It should be appreciated that embodiments of the present invention provide at least for creating/updating/modifying a model for predicting and optimizing asset work plans. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting asset program 112 to creating/updating/modifying a model for predicting and optimizing asset work plans.

Asset program 112 receives historical work data (step 202). At step 202, asset program 112 receives historical work data, including but not limited to, completion time, completion cost, and crew qualifications to complete one or more previously completed jobs. In an embodiment, asset program 112 may historical work data from a user of computing device 110 that inputs the information manually or inputs the historical work data from a database, storage device, or the like. In an alternative embodiment, asset program 112 may receive the historical work data from an asset management program (not shown) that processes and/or manages work orders.

Asset program 112 analyzes historical work data (step 204). At step 204, asset program 112 analyzes the historical work data received in step 202. In an embodiment, historical work data received includes information about one or more jobs completed previously. In an embodiment, asset program 112 analyzes each job of the one or more jobs completed previously to determine whether the time to complete, cost to complete, and/or crew qualifications to complete the job is included. In an embodiment, asset program 112 analyzes each job of the one or more jobs completed to determine estimated data and actual data. In other words, asset program 112 determines the estimated time to complete the job and the actual time to complete the job and similarly for cost of the job and crew qualifications for the job. In an embodiment, asset program 112 determines the dates the jobs were scheduled to be completed and dates the jobs were actually completed. In an embodiment, asset program 112 can convert crew qualifications into a bag-of-words vector to analyze crew qualifications and make the crew qualifications useful for the model.

In an embodiment, asset program 112 may determine whether each job of the one or more jobs completed previously includes a job plan. In an embodiment, a job plan describes the job to be completed, including but not limited to tasks, materials, services, tools, etc. that is performed for the job (i.e. work order) and is used to cluster or associate jobs by similar job types. In an embodiment, asset program 112 may use a cluster algorithm, (e.g., k-means), to create clusters of job plans and then create template plans that can be inferred from the work orders of the same clusters. In an embodiment, asset program 112 uses work data templates, found in information repository 114, to determine clusters of template plans. In an embodiment, work data templates is a database that lists jobs, associated or similar jobs to other jobs, and example clusters of jobs. For example, installing electrical for a wind turbine may be associated or similar with installing turbines for a wind turbine due to the jobs being both including a wind turbine. In an alternative example, installing electrical for a wind turbine may be associated or similar with installing electrical for a new store due to the jobs both including installing electrical.

Asset program 112 infers historical work data (step 206). At step 206, asset program 112, based on the analyzed historical work data, determines any information, for example time data, cost data, crew qualifications data, etc., that may be missing from the one or more jobs completed previously. In an embodiment, asset program 112 may request a user or asset management program (not shown) for the missing information. In an alternative embodiment, asset program 112 may infer the missing information based on other received historical work data. In other words, asset program 112 may determine missing information in a first job based on received information in one or more other jobs. For example, if a first job related to installing electrical for a wind turbine is missing cost of materials for the electrical and a second job related to installing electrical for a new store has the cost of materials for the electrical, asset program 112 may infer or estimate the cost of electrical that is missing based on the cost of material for the electrical in the new store.

Asset program 112 receives historical weather data (step 208). At step 208, asset program 112 receives historical weather data for the location and time that each job received in step 202. In an embodiment, asset program 112 receives historical weather data for the time the job was scheduled to be completed and the time the job was actually completed. In an embodiment, asset program 112 may receive the historical weather data via user input. In an alternative embodiment, asset program 112 may receive the historical weather data from a database such as one associated with a weather company or government weather data. In an embodiment, weather data includes, but is not limited to, temperature, humidity, percent sunshine, percent clouds, wind speed, percent chance of precipitation, actual recorded precipitation levels, atmospheric pressure, etc.

Asset program 112 trains a model (step 210). At step 210, asset program 112 trains a model using the historical work data and historical weather data. In an embodiment, asset program 112 may train a model for all work orders. In an alternative embodiment, asset program 112 may train a model for all work order associated with a user or group of users (i.e., company, or organization). In yet another alternative embodiment, asset program 112 may train a model for each for a work data template. In other words, asset program 112 may train a model for jobs related to wind turbines and train another model for jobs related to new stores. In an embodiment, asset program 112 may continually receive updated data via step 202 or in any other manner and asset program 112 may use this data to continually update the model.

In an embodiment, asset program 112 will train a model that predicts time deviations and cost deviations based on an input of a work order. In an embodiment, asset program 112 uses machine learning techniques, including but not limited to, support vector machine (SVM) or neural networks. In an embodiment, asset program 112 may be able to receive inputs of planned time, planned cost, and planned crew qualifications along with predicted weather conditions to determine time deviations, cost deviations, and crew qualification deviations for a received work order. In an embodiment, asset program 112 trains the model to use cluster data based on the received historical work data and historical weather data to correlate the influence of all variables (time, cost, crew qualifications, etc.). In an embodiment, asset program 112 may train the model to use future engineer techniques and/or information gain measures, such as entropy. In an embodiment, information entropy or just entropy, is a basic quantity in information theory associated to any random variable, which can be interpreted as the average level of “information”, “surprise”, or “uncertainty” inherent in the variable's possible outcomes. The higher the entropy is, the higher is the relevance of the variable in a given dataset. In an embodiment, asset program 112 will compute work order time deviations using the planned time to complete a job compared to the executed time for the job and asset program 112 will computer cost deviations using the planned cost and the executed cost. In an embodiment, asset program 112 will use these deviations to train the model.

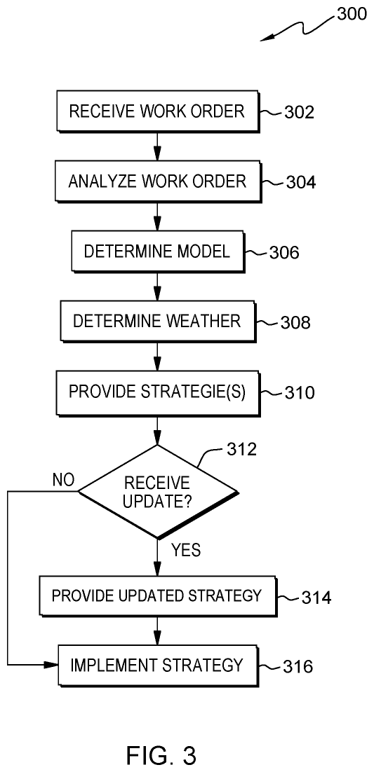

FIG. 3 is a flow chart diagram of workflow 300 depicting operational steps for asset program 112 in accordance with at least one embodiment of the invention. In an alternative embodiment, the steps of workflow 200 may be performed by any other program while working with asset program 112. It should be appreciated that embodiments of the present invention provide at least for receiving a work order and using a model to predict and optimize asset work plans. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting asset program 112 to predict and optimize an asset work plan based on inputting a work order.

Asset program 112 receives a work order (step 302). At step 302, asset program 112 receives a work order form a user via the user interface of computing device 110. In an alternative embodiment, asset program 112 receives a work order form an asset management program. In an embodiment, the work order may include a specific time requested for the work order to be completed, an estimated length of time to complete the job, an estimated cost of the job, and an estimated crew qualifications for the job. In an embodiment, asset program 112 can convert crew qualifications into a bag-of-words vector to analyze crew qualifications and make the crew qualifications useful for the model.

Asset program 112 analyzes the work order (step 304). At step 304, asset program 112 analyzes the work order received in step 304. In an embodiment, asset program 112 determines whether the work order includes a template plan. In an embodiment, asset program 112 determines whether the work order is missing any information, for example the estimated cost of the job, and if any information is missing, asset program 112 requests updated or additional information. In an embodiment, asset program 112 may request more information via the user interface of computing device or may request for information from an asset management program (not shown).

Asset program 112 determines a model (step 306). At step 306, asset program 112 determines a model to use. In an embodiment, there may be only a single model and asset program 112 will use the single model. In an alternative embodiment, asset program 112 may determine the model that is associated with the submitted work order. In other words, if User A submitted the work order, asset program 112 may determine to use the model associated with User A. In yet another alternative embedment, asset program 112 may determine the model that is associated with the template plan of the work order. In other words, if the work order is has to do with wind turbines, asset program 112 may determine the model that is associated with wind turbines.

Asset program 112 determines the weather (step 308). At step 308, asset program 112 receives predicted weather data for the location and time for the work order received in step 302. In an embodiment, asset program 112 receives predicted weather data for the time the job and location the job is scheduled to be completed. In an alternative embodiment, asset program 112 also receives predicted weather data within a time range for the time the job is scheduled to be completed. In other words, asset program 112 receives predicted weather data for the date the job is scheduled to be completed and also a weather data for the week before the date the job is scheduled to be completed and for the week after the date the job is scheduled to be completed. In an embodiment, asset program 112 may receive the predicted weather data via user input. In an alternative embodiment, asset program 112 may receive the predicted weather data from a database such as one associated with a weather company or government weather data.

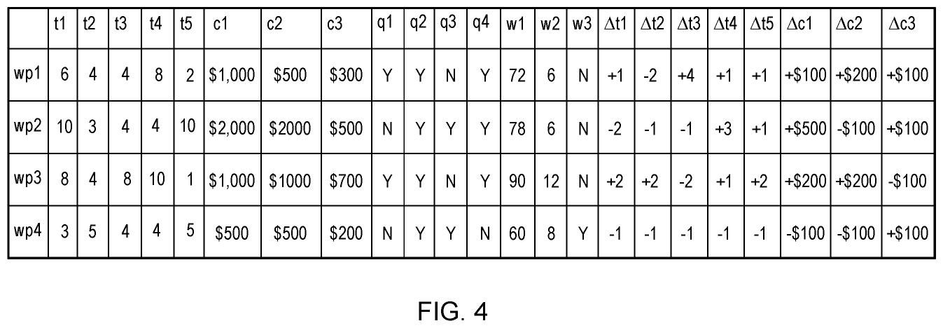

Asset program 112 provides strategies (step 310). At step 310, asset program 112 determines one or more strategies to complete the work order received in step 302 using the determined model and the determined weather. In an embodiment, asset program 112 may provide the strategies to the user via the user interface (not shown) of computer 110. In an alternative embodiment, asset program 112 may provide the strategies to asset management program (not shown). Example strategies along with provided information will be discussed more in depth in reference to FIG. 4.

Asset program 112 determines whether an update was received (decision step 312). At decision step 308, asset program 112 determines whether an update to the work order was received from a user. In an alternative embodiment, asset program 112 determines whether an update to the work order was received from the asset management program (not shown). In an embodiment, the user or asset management program may choose to update the work order in response to the provided strategies. In response to an update being received (decision step 312, yes branch), processing proceeds to providing an updated strategy (step 314). In response to no update being received (decision step 312, no branch), processing proceeds to implementing the strategy (step 316).

Asset program 112 provides an updated strategy (step 314). At step 314, asset program 112 provides a strategy, similar to step 310, using the updated work order. In other words, asset program 112 provides an updated strategy that utilizes the updated work order.

Asset program 112 implements the strategy (step 316). At step 316, asset program 112 receives an indication, from the user or asset management program (not shown) of a chosen strategy. Asset program 112 then determines what is needed to implement the chosen strategy. In an embodiment, asset program 112 may setup calendar information for work orders and timing of the work order to be completed based on the chosen strategy. In another embodiment, asset program 112 may order supplies or other products needed to complete the work order based on the timing and costs of the work order. In an embodiment, asset program 112, once a strategy is chosen by a user, may execute the work order. In an embodiment, asset program 112, once the strategy is chosen by a user, asset program 112 may postpone the work order execution and in doing so reduce the overall work order time and/or cost.

FIG. 4 is an example table 400 depicting work orders and their associated data, in accordance with at least one embodiment of the invention. FIG. 4 includes multiples rows and each row represents a work orders. Work orders, or work plans, are numbered (e.g., wp1, wp2, etc.), as shown in work plan column 402. In this example, there are four work plans. FIG. 4 includes multiples columns. In example table 400, planned time column(s) 404 is the planned time, in hours, for each task in the work plan. In this example, each work plan has five tasks. In example table 400, planned cost column(s) 406 is the planned cost, in dollars, for each work order (e.g., material cost, service cost, etc.). In this example, the first cost is material cost, the second cost is installation cost, and third cost is ancillary costs. In example table 400, crew qualification column(s) 408 is the crew qualifications required for the work order. In this example, the first crew qualification is a supervisor, the second crew qualification is workers, the third crew qualification is a welder, and the fourth crew qualification is an electrician. In example table 400, weather qualification column(s) 410 is the weather conditions (e.g., humidity, wind speed, pressure, temperature, etc.) for the work order based on the time of the work order and time deviations. In this example, the first weather qualification is temperature in Fahrenheit, the second weather qualification is wind speed in mph, and the third weather qualification is rain (yes or no). In example table 400, delta time column(s) 412 is the difference from the planned time and the executed time that has been predicted by the model. In example table 400, delta cost column(s) 414 is the difference from the planned cost and the executed cost in dollars that has been predicted by the model.

In FIG. 4, asset program 112 has provided a strategy for four different work order, or work plans numbered wp1-wp4, as shown in column 402. In an embodiment, each work plan may be shown separately, for example if a first user requested asset program 112 to analyze a first work plan and a second user requested asset program 112 to analyze a second work plan. In this example, as discussed above, four separate work plans were received and their respective times for each task along with costs were input into asset program 112. In this example, asset program 112 has analyzed the work plans using a the model describe above to provide strategies and their deviations in time and costs, as shown in columns 412 and columns 414 respectively.

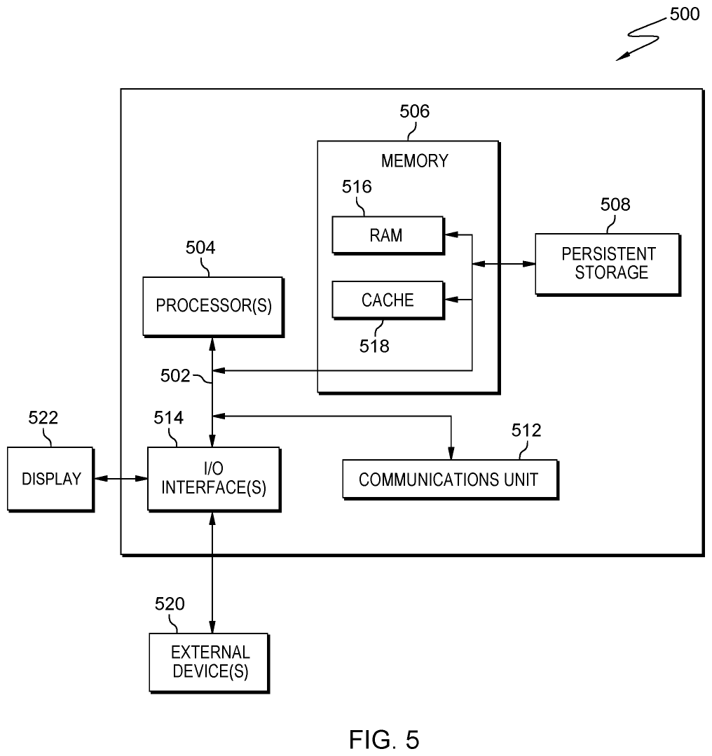

FIG. 5 is a block diagram depicting components of a computer 500 suitable for asset program 112, in accordance with at least one embodiment of the invention. FIG. 5 displays the computer 500, one or more processor(s) 504 (including one or more computer processors), a communications fabric 502, a memory 506 including, a RAM 516, and a cache 518, a persistent storage 508, a communications unit 512, I/O interfaces 514, a display 522, and external devices 520. It should be appreciated that FIG. 3 provides only an illustration of one embodiment and does not imply any limitations with regard to the environments in which different embodiments may be implemented. Many modifications to the depicted environment may be made.

As depicted, the computer 500 operates over the communications fabric 502, which provides communications between the computer processor(s) 504, memory 506, persistent storage 508, communications unit 512, and input/output (I/O) interface(s) 514. The communications fabric 502 may be implemented with an architecture suitable for passing data or control information between the processors 504 (e.g., microprocessors, communications processors, and network processors), the memory 506, the external devices 520, and any other hardware components within a system. For example, the communications fabric 502 may be implemented with one or more buses.

The memory 506 and persistent storage 508 are computer readable storage media. In the depicted embodiment, the memory 506 comprises a random-access memory (RAM) 516 and a cache 518. In general, the memory 506 may comprise any suitable volatile or non-volatile one or more computer readable storage media.

Program instructions asset program 112 may be stored in the persistent storage 508, or more generally, any computer readable storage media, for execution by one or more of the respective computer processors 504 via one or more memories of the memory 506. The persistent storage 508 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 508 may also be removable. For example, a removable hard chive may be used for persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 may comprise one or more network interface cards. The communications unit 512 may provide communications through the use of either or both physical and wireless communications links. In the context of some embodiments of the present invention, the source of the various input data may be physically remote to the computer 500 such that the input data may be received, and the output similarly transmitted via the communications unit 512.

The I/O interface(s) 514 allow for input and output of data with other devices that may operate in conjunction with the computer 500. For example, the I/O interface 514 may provide a connection to the external devices 520, which may be as a keyboard, keypad, a touch screen, or other suitable input devices. External devices 520 may also include portable computer readable storage media, for example thumb drives, portable optical or magnetic disks, and memory cards. Software and data used to practice embodiments of the present invention may be stored on such portable computer readable storage media and may be loaded onto the persistent storage 508 via the I/O interface(s) 514. The I/O interface(s) 514 may similarly connect to a display 522. The display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (MID), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for providing a work order strategy, the computer implemented method comprising:
receiving, by one or more computer processors, historical work data for one or more previously completed jobs;
analyzing, by one or more computer processors, the historical work data;
receiving, by one or more computer processors, weather data for each previously completed job of the one or more previously completed jobs, wherein the weather data is at a time of completion of the previously completed job;
training, by one or more computer processors, a model using the analyzed historic work data and the weather data, wherein the model predicts a time deviation, a cost deviation, and crew qualifications based on a work order.

2. The computer-implemented method of claim 1, further comprising:
receiving, by one or more computer processors, the work order;
receiving, by one or more computer processors, a predicted weather conditions for one or more times the work order is to be completed; and
determining, by one or more computer processors; one or more time deviations, one or more cost deviations, and one or more crew qualifications based on the work order using the model.

3. The computer-implemented method of claim 1, wherein the historical work data is selected from the group consisting of completion time, completion cost, and crew qualifications.

4. The computer-implemented method of claim 1, wherein analyzing, by one or more computer processors, the historical work data includes using a k-means cluster algorithm to create a template plan for each created cluster of jobs from the one or more previously completed jobs.

5. The computer-implemented method of claim 2, further comprising:
providing, by one or more computer processors, the one or more time deviations, one or more cost deviations, and one or more crew qualifications to a user via a user interface of a computing device.

6. The computer-implemented method of claim 1, further comprising:
determining, by one or more computer processors, one or more missing information from the analyzed historical work data;
requesting, by or more computer processors, the one or more missing information from a user;
receiving, by one or more computer processors, the one or more missing information; and
updating, by one more computer processors, the analyzed historical work data with the one or more missing information.

7. The computer-implemented method of claim 4, further comprising:
determining; by one or more computer processors, one or more missing information from the analyzed historical work data, wherein the one or more missing information is from a first job;
determining, by one or more computer processors, a cluster of jobs associated with the first job; and
updating, by one more computer processors, the analyzed historical work data by inferring the missing information using the cluster of jobs associated with the first job.

8. A computer program product for providing a work order strategy, the computer program product comprising:
one or more co eatable storage media; and
program instructions stored on the one or more computer readable storage media, the program instructions comprising:
program instructions to receive historical work data for one or more previously completed jobs;
program instructions to analyze the historical work data;
program instructions to receive weather data for each previously completed job of the one or more previously completed jobs, wherein the weather data is at a time of completion of the previously completed job; and
program instructions to train a model using the analyzed historic work data and the weather data, wherein the model predicts a time deviation, a cost deviation; and crew qualifications based on a work order.

9. The computer program product of claim 8, further comprising program instructions stored on the one or more computer readable storage media, to:
receive the work order;
receive a predicted weather conditions for one or more times the work order is to be completed; and
determine one or more time deviations; one or more cost deviations, and one or more crew qualifications based on the work order using the model.

10. The computer program product of claim 8, wherein the historical work data is selected from the group consisting of completion time; completion cost, and crew qualifications.

11. The computer program product of claim 8, wherein the program instructions to analyze the historical work data includes using a k-means cluster algorithm to create a template plan for each created cluster of jobs from the one or more previously completed jobs.

12. The computer program product of claim 9, further comprising program instructions stored on the one or more computer readable storage media, to:
provide the one or more time deviations, one or more cost deviations, and one or more crew qualifications to a user via a user interface of a computing device.

13. The computer program product of claim 8, further comprising program instructions stored on the one or more computer readable storage media, to:
determine one or more missing information from the analyzed historical work data;
request the one or more missing information from a user;
receive the one or more missing information; and
update the analyzed historical work data with the one or more missing information.

14. The computer program product of claim 11, further comprising program instructions stored on the one or more computer readable storage media, to:
determine one or more missing information from the analyzed historical work data, wherein the one or more missing information is from a first job;
determine a cluster of jobs associated with the first job; and
update the analyzed historical work data by inferring the missing information using the cluster of jobs associated with the first job.

15. A computer system for providing a work order strategy, the computer system comprising:
one or more computer processors;
one or more computer readable storage media; and
program instructions, stored on the one or more computer readable storage media for execution by at least one of the one or more computer processors, the program instructions comprising:
program instructions to receive historical work data for one or more previously completed jobs;
program instructions to analyze the historical work data;
program instructions to receive weather data for each previously completed job of the one or more previously completed jobs, wherein the weather data is at a time of completion of the previously completed job; and
program instructions to train a model using the analyzed historic work data and the weather data, wherein the model predicts a time deviation, a cost deviation, and crew qualifications based on a work order.

16. The computer system of claim 15, further comprising program instructions, stored on the one or more computer readable storage media for execution by at least one of the one or more computer processors, to:
receive the work order;
receive a predicted weather conditions for one or more times the work order is to be completed; and
determine one or more time deviations, one or more cost deviations, and one or more crew qualifications based on the work order using the model.

17. The computer system of claim 15, wherein the historical work data is selected from the group consisting of completion time, completion cost, and crew qualifications.

18. The computer system of claim 15, wherein the program instructions to analyze the historical work data includes using a k-means cluster algorithm to create a template plan for each created cluster of jobs from the one or more previously completed jobs.

19. The computer system of claim 16, further comprising program instructions, stored on the one or more computer readable storage media for execution by at least one of the one or more computer processors, to:
provide the one or more time deviations, one or more cost deviations, and one or more crew qualifications to a user via a user interface of a computing device.

20. The computer system of claim 15, further comprising program instructions, stored on the one or more computer readable storage media for execution by at least one of the one or more computer processors, to:
determine one or more missing information from the analyzed historical work data;
request the one or more missing information from a user;
receive the one or more missing information; and
update the analyzed historical work data with the one or more missing information.
